(19) United States
(12) Patent Application Publication
(10) Pub. No.: US 2010/0021040 A1
(43) Pub. Date: Jan. 28, 2010

(54) PATTERN EVALUATION APPARATUS AND PATTERN EVALUATION METHOD

(76) Inventor: Akiko KAWAMOTO, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/504,079

(22) Filed: Jul. 16, 2009

(30) Foreign Application Priority Data
Jul. 28, 2008 (JP) 2008-193721

(51) Int. Cl. G06K 9/00

(52) U.S. Cl. 382/141

(57) ABSTRACT

A method of evaluating a pattern includes: generating a first reference pattern as evaluation reference of an inspection pattern; varying a process parameter for manufacturing the first reference pattern and generating a variation pattern group comprising patterns varied in shape from the first reference pattern according to varied process parameters; defining a second reference pattern as reference in calculating a shape variation amount in the variation pattern group; obtaining coordinates of edge points of the second reference pattern and the variation pattern group; conducting association between the edge points of the second reference pattern and of the variation pattern group; calculating a shape variation amount in the variation pattern group; adding the calculated shape variation amount to information of the edge points of the second reference pattern; and conducting matching between the inspection pattern and the second reference pattern with the shape variation amount being added.

### CROSS REFERENCE TO RELATED APPLICATION

This application claims benefit of priority under 35 USC §119 to Japanese patent application No. 2008-193721, filed on Jul. 28, 2008, the contents of which are incorporated by reference herein.

### BACKGROUND OF THE INVENTION

1. Field of the Invention

The present invention relates to a pattern evaluation apparatus and a pattern evaluation method.

2. Related Background Art

In various industrial fields an evaluation method is adopted in which a difference between a pattern to be inspected (hereafter referred to as “inspection pattern”) and a design pattern or a pattern serving as reference (hereafter referred to as “reference pattern”) is quantified and a resultant value is used as an index. For example, there is an evaluation method for a semiconductor device pattern in which a first array data is generated from edge data on an inspection pattern, a second array data is generated from edge data on a reference pattern, a third array data is generated by subjecting the second array data to array conversion processing, and matching between the inspection pattern and the reference pattern is conducted by executing arithmetic processing between the first array data and the third array data, thereby the degree of deviation of the inspection pattern from the reference pattern is calculated (for example, Japanese Patent Laid-Open Pub. No. 2006-275952).

If the inspection pattern is different from the reference pattern remarkably, however, it is impossible to match the inspection pattern with the reference pattern suitably even when the method disclosed in Japanese Patent Laid-Open Pub. No. 2006-275952 is used. In addition, if appropriate matching is not conducted, it is impossible to accurately calculate the degree of deviation of the inspection pattern from the reference pattern, either.

### SUMMARY OF THE INVENTION

According to a first aspect of the present invention, there is provided a pattern evaluation apparatus comprising:

a variation pattern group generation unit configured to receive information on a first reference pattern serving as evaluation reference of an inspection pattern, vary a process parameter for manufacturing the first reference pattern, and generate a variation pattern group comprising a plurality of patterns that are varied in shape from the first reference pattern according to a plurality of obtained process parameters, respectively;

a detection unit configured to receive information on a second reference pattern serving as reference in calculating a shape variation amount in the variation pattern group, detect edge points of the second reference pattern and the variation pattern group, and output coordinate information of the detected edge points;

an edge point association unit configured to conduct mutual association between the edge points of the second reference pattern and the edge points of the variation pattern group;

a shape variation amount calculation unit configured to calculate a shape variation amount in the variation pattern group from the coordinate information of the associated edge points;

a shape variation amount addition unit configured to add the calculated shape variation amount to information of the edge points of the second reference pattern; and

a pattern matching unit configured to conduct matching between the second reference pattern and the inspection pattern by using the second reference pattern with the shape variation amount being added.

According to a second aspect of the present invention, there is provided a method of evaluating a pattern comprising:

generating a first reference pattern serving as evaluation reference of an inspection pattern;

varying a process parameter for manufacturing the first reference pattern and generating a variation pattern group comprising a plurality of patterns that are varied in shape from the first reference pattern according to a plurality of obtained process parameters, respectively;

defining a pattern which serves as reference in calculating a shape variation amount in the variation pattern group, as a second reference pattern;

obtaining coordinates of edge points of the second reference pattern and the variation pattern group;

conducting association between the edge points of the second reference pattern and the edge points of the variation pattern group;

calculating a shape variation amount in the variation pattern group from the coordinates of the associated edge points;

adding the calculated shape variation amount to information of the edge points of the second reference pattern; and

conducting matching between the inspection pattern and the second reference pattern with the shape variation amount being added.

### BRIEF DESCRIPTION OF THE DRAWINGS

FIG. 1 is a block diagram showing an embodiment of a pattern evaluation apparatus according to the present invention;

FIG. 2 is a flow chart showing a rough procedure of a first embodiment of a pattern evaluation method according to the present invention;

FIG. 3 is a diagram showing an example of a variation pattern group;

FIG. 4 is a diagram showing an example of edge matching;

FIG. 5 is a diagram showing an example of association of edge points;

FIG. 6 is a diagram showing an example of a second reference pattern with information of a shape variation amount being added;

FIGS. 7 to 9 are diagrams explaining a conventional art as a comparative example;

FIG. 10 is a diagram showing an example of pattern matching conducted with the use of the pattern evaluation method shown in FIG. 2; and

FIG. 11 is a diagram explaining a second embodiment of the pattern evaluation method according to the present invention.

### DETAILED DESCRIPTION OF THE INVENTION

Embodiments of the present invention will be described below with reference to the drawings. In the drawings, the same parts are denoted by like reference numbers, and duplicated description thereof will not be repeated.

(1) Pattern Evaluation Apparatus

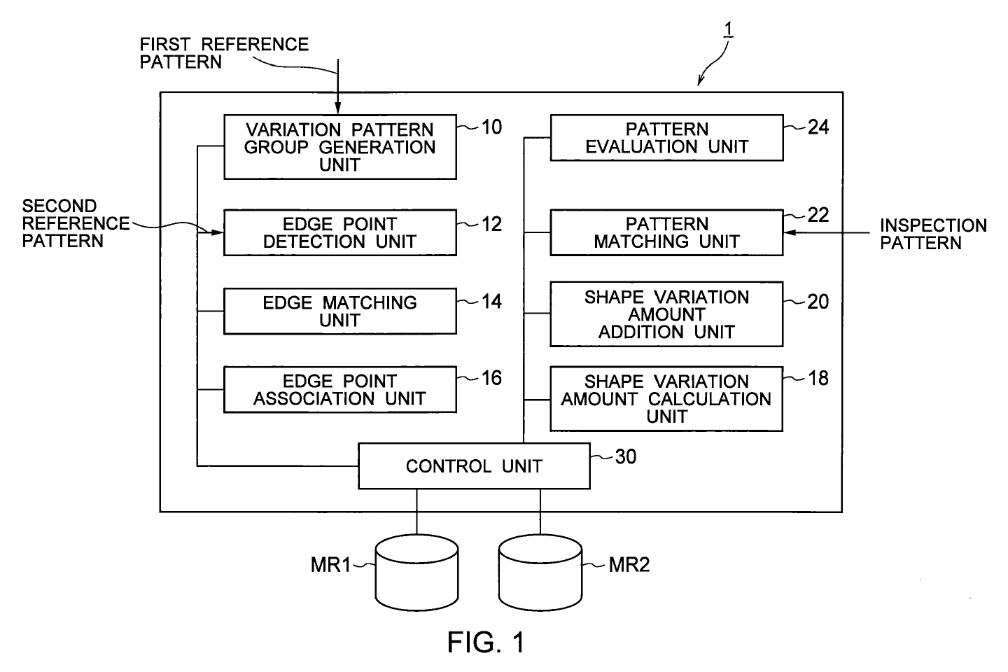

FIG. 1 is a block diagram showing an embodiment of a pattern evaluation apparatus according to the present invention. A pattern evaluation apparatus 1 shown in FIG. 1 includes a variation pattern group generation unit 10, an edge point detection unit 12, an edge matching unit 14, an edge point association unit 16, a shape variation amount calculation unit 18, a shape variation amount addition unit 20, a pattern matching unit 22, a pattern evaluation unit 24 and a control unit 30.

The control unit 30 is connected to other components in the apparatus to control the whole apparatus. The control unit 30 is connected to storage devices MR1 and MR2 which are incorporated in the apparatus or located outside the apparatus, to read or write data. A recipe file which describes specific procedures of a pattern evaluation method according to the present invention described later is stored in the storage device MR1. The control unit 30 reads out this recipe file from the storage device MR1 and executes pattern evaluation.

Operation of the pattern evaluation apparatus 1 shown in FIG. 1 will now be described as an embodiment of a pattern evaluation method according to the present invention.

(2) First Embodiment of Pattern Evaluation Method

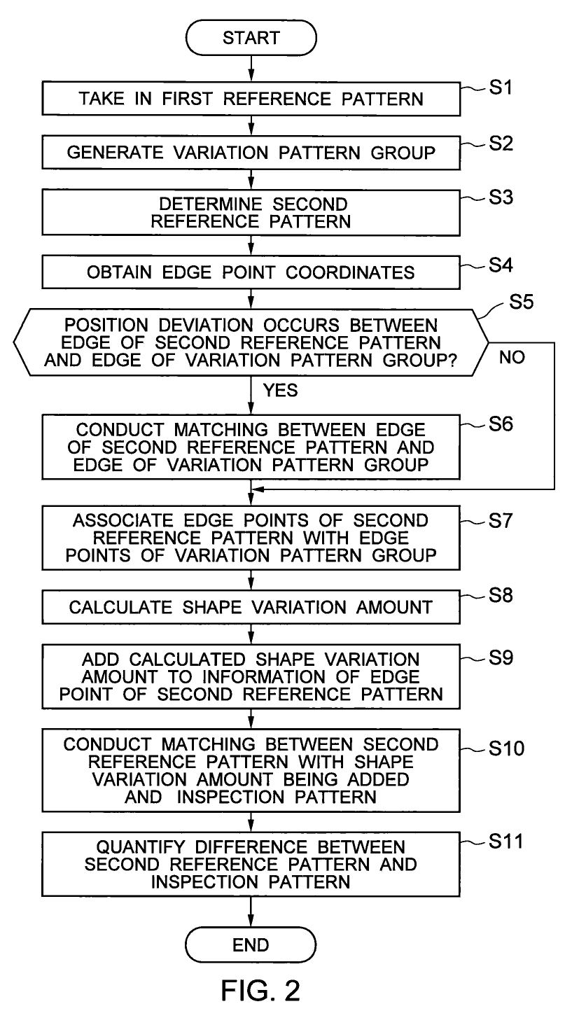

FIG. 2 is a flow chart explaining rough procedures of the pattern evaluation method according to the present embodiment.

First, the variation pattern group generation unit 10 receives an input of a pattern (hereafter referred to as “first reference pattern”) serving as an evaluation reference for the inspection pattern (step S1), generates a variation pattern group, and outputs its image data (step S2). As for generation of the variation pattern group, it may be generated by simulation or it may be generated by utilizing an image acquired using a Scanning Electron Microscope (SEM) from a pattern generated by actually changing process parameters. Image data of the variation pattern group is stored in the storage device MR2 via the control unit 30.

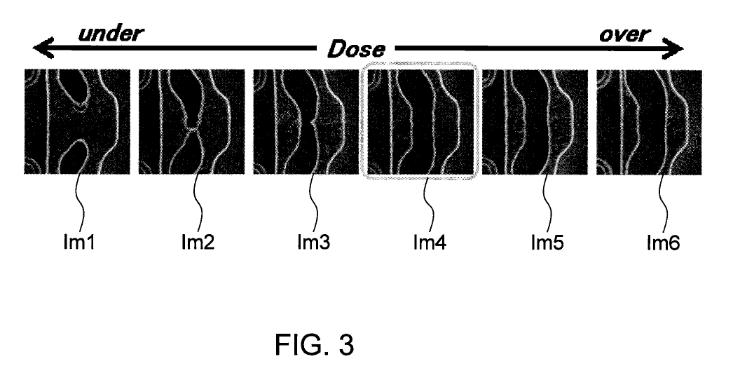

Here, the “variation pattern group” means an aggregate of a plurality of patterns which have changed in shape according to a variation of process parameters of a manufacturing apparatus in actually manufacturing the first reference pattern. For example, if process parameters of an aligner are varied and the first reference pattern is exposed, then the obtained pattern has a shape different from that of the first reference pattern according to change quantities of the process parameters. An example of the variation pattern group is shown in FIG. 3. FIG. 3 shows images Im1 to Im6 of a pattern which has changed in shape according to the variation amount by varying the dose amount of the aligner in six stages. Besides the dose, for example, the exposure wavelength, numerical aperture (NA) of a lens of the aligner, illumination shape (σ, ε) of the aligner, phase and transmittance of the mask, and parameters of development and the resist process are included in the process parameters.

Subsequently, an operator selects a pattern (hereafter referred to as “second reference pattern”) serving as a reference for calculating the variation amount of the shape in the variation pattern group, from the variation pattern group (step S3), and orders the control unit 30 via an input unit (not shown) to store the selected pattern in the storage device MR2. In the example shown in FIG. 3, the pattern of the image Im4 is selected as the second reference pattern. In the present embodiment, a pattern belonging to the variation pattern group has been selected as the second reference pattern. However, the second pattern is not restricted to a pattern belonging to the variation pattern group. For example, design data of the inspection pattern can also be adopted. A pattern estimated by executing a simulation may also be used. In this case, it is desirable to provide the variation pattern group generation unit 10 shown in FIG. 1 with a function of a simulator. As the second reference pattern, the same pattern as the first reference pattern may be selected, the most average pattern in the variation pattern group may be selected, or a pattern which is the closest to an article of good quality may be selected.

Subsequently, the edge point detection unit 12 detects a pattern edge for each of the image of the second reference pattern and images of the variation pattern group, obtains coordinate information of a detected edge point (step S4), and stores the coordinate information in the storage device MR2 via the control unit 30.

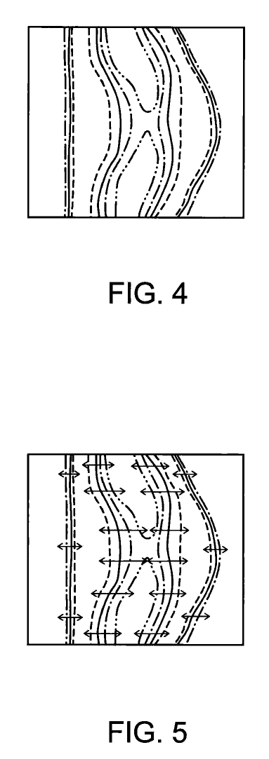

Subsequently, the edge matching unit 14 makes a decision whether position deviation occurs between the second reference pattern and the variation pattern group (step S5). If position deviation has occurred, the edge matching unit 14 conducts matching between each variation pattern in the variation pattern group and the second reference pattern so as to cause coordinates of the detected edge point to become the closest (step S6). In the matching, any one of techniques typically used in image processing may be used. An example of matching according to this procedure is shown in FIG. 4. In FIG. 4, solid lines represent the second reference pattern. In FIG. 4, dash lines, one-dot dash lines and two-dot dash lines represent patterns of images Im5, Im3 and Im2 shown in FIG. 3, respectively. Coordinate information of edge points after the matching is stored in the storage device MR2 via the control unit 30.

Subsequently, the edge point association unit 16 divides the matched edge points of the second reference pattern and edge points of the variation pattern group into segments, and associates edge points of the second reference pattern with edge points of the variation pattern group in each segment (step S7).

An example of association of edge points is shown in FIG. 5. Information of associated edge points is stored in the storage device MR2 via the control unit 30. Here, the size of segments in division can be arbitrarily defined by the user.

Subsequently, the shape variation amount calculation unit 18 calculates a distance between edge points in patterns included in each segment, and outputs the distance as a shape variation amount (step S8). Examples of the calculated distance are indicated by arrows in FIG. 5.

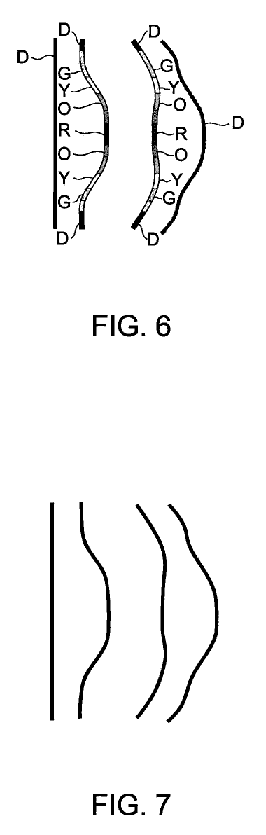

Subsequently, the shape variation amount addition unit 20 adds information of the shape variation amount of each segment to information of the edge point of the second reference pattern (step S9). An example of the second reference pattern with information of the shape variation amount added is shown in FIG. 6. In the example shown in FIG. 6, magnitudes of the variation amount are classified into five stages. The five stages are respectively provided with colors, i.e., R (red), O (orange), Y (yellow), G (green) and D (dark blue) in the order of decreasing variation amount for visualization. Hereafter, the shape variation amount thus given to the second reference pattern is referred to as “variation amount distribution.”

In addition, the pattern matching unit 22 receives an input of an image of an inspection pattern, and conducts matching between the inspection pattern and the second reference pattern with the shape variation amount added (step S10). The matching is conducted so as to minimize an index corresponding to the distance between the second reference pattern and the inspection pattern. When calculating the index corresponding to the distance between the second reference pattern and the inspection pattern, a point where the shape variation amount calculated according to the procedure at the step S8 is small is provided with a comparatively large weight, whereas a point where the shape variation amount is large is provided with a comparatively small weight.

Finally, the pattern evaluation unit 24 quantifies the difference between the second reference pattern and the inspection pattern by calculating the index corresponding to the distance between the second reference pattern and the inspection pattern, and outputs the calculated index as an evaluation index of the inspection pattern (step S11). When quantifying the difference at this time, a point where the shape variation amount calculated according to the procedure at the step S8 is large is provided with a comparatively large weight, whereas a point where the shape variation amount is small is provided with a comparatively small weight, in contrast with the time of the matching. The pattern evaluation unit 24 corresponds to, for example, a difference quantifying unit in the present embodiment.

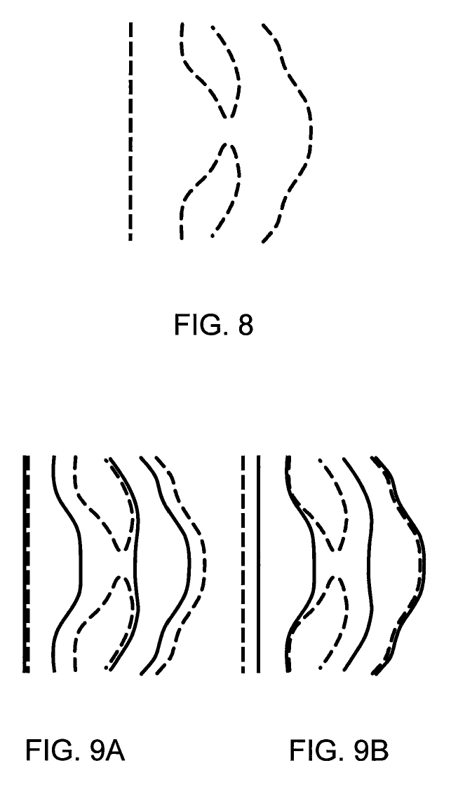

Effects of the present embodiment will be described by contrasting it with a prior art. Solid lines in FIG. 7 represent an example of a reference pattern used in a conventional pattern evaluation. Dash lines in FIG. 8 represent an example of an inspection pattern. FIGS. 9A and 9B show concrete examples of matching mistakes between the reference pattern and the inspection pattern in the conventional art. In the conventional art, shape differences between the patterns shown in FIGS. 7 and 8 are remarkable. As shown in FIG. 9, therefore, appropriate matching is impossible. In such a case where appropriate matching is not conducted, the deviation of the inspection pattern from the reference pattern cannot be calculated with high precision, either.

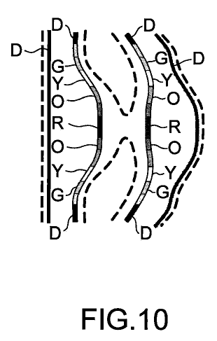

An example of matching according to the present embodiment is shown in FIG. 10. Even if the shapes are different remarkably between patterns, appropriate matching between the second reference pattern and the inspection pattern becomes possible as shown in FIG. 10.

Furthermore, according to the present embodiment, the second reference pattern with the shape variation amount caused by variations of the process parameters added is used. Therefore, pattern evaluation having sensitivity to the shape variation becomes possible. As a result, it also becomes possible to calculate the degree of deviation of the inspection pattern from the reference pattern with high precision.

Furthermore, when quantifying the difference between the second reference pattern and the inspection pattern, weighting according to the magnitude of the shape variation amount is conducted and the weights are further added to the information of the edge points of the second reference pattern. According to the present embodiment, therefore, weighting at the time of pattern evaluation can be conducted automatically and suitably. As a result, more realistic pattern evaluation becomes possible.

(3) Second Embodiment of Pattern Evaluation Method

When evaluating a semiconductor pattern over a wide range of the substrate surface, it is desirable to divide a surface of the substrate on which a pattern is formed, into a plurality of regions, acquire images of respective regions, then calculate shape variation amounts of respective patterns and generate variation amount distribution according to substantially the same procedures as those of the first embodiment.

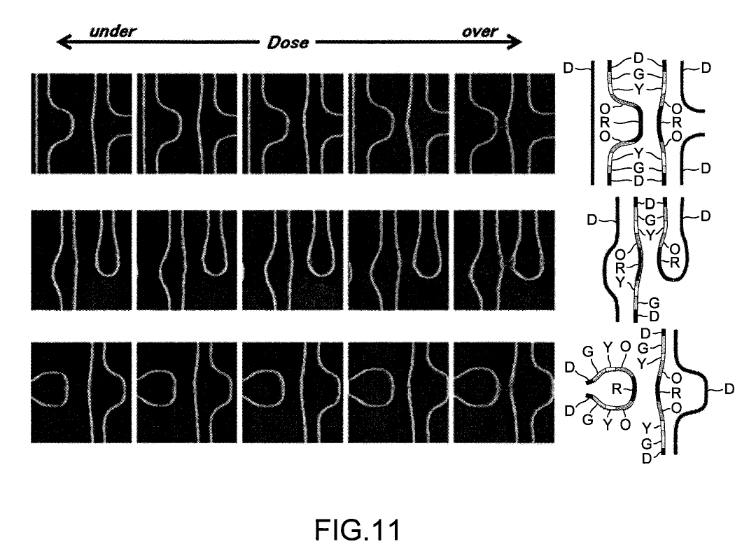

FIG. 11 shows examples of images of three regions on a substrate and examples of variation amount distribution corresponding to respective images which are acquired by using the pattern evaluation method according to the present embodiment. In according with the present embodiment, the variation amount distribution is thus acquired over a wide range. Therefore, it becomes possible to compare patterns on the substrate based on the magnitude of the shape variation amount. For example, it is also possible to detect a pattern which is, e.g., the largest in variation amounts in a region of wide range.

(4) Program

In the above-described embodiments, a series of procedures of the pattern evaluation method are stored in the storage device MR1 as a recipe file, read into the pattern evaluation apparatus 1, and executed. However, the series of procedures of the pattern evaluation method described above may be incorporated into a program, read into a general purpose computer, and executed. As a result, the pattern evaluation method according to the present invention can be implemented by using a general purpose computer which can conduct image processing. It is also possible to store the series of procedures of the pattern evaluation method explained above into a recording medium such as a flexible disk or a CD-ROM as a program to be executed by a computer, and cause a general purpose computer which is capable of conducting image processing to read the program, take in image data of inspection patterns from an image acquisition apparatus such as a Scanning Electron Microscope (SEM), and execute the program.

The recording medium is not restricted to a portable medium such as a magnetic disk or an optical disk, but may be a stationary recording medium such as a hard disk device or a memory. A program having the series of procedures of the pattern evaluation method incorporated therein may also be distributed via a communication line such as Internet (inclusive of wireless communication).

(5) Manufacturing Method of Semiconductor Device

When the pattern inspection method described above is used in a manufacturing process of a semiconductor device, a pattern can be inspected with high accuracy and high efficiency, the semiconductor device can thus be manufactured with a higher throughput and a higher yield ratio.

More specifically, a substrate is sampled in units of production lot, and a pattern formed on the sampled substrate is inspected based on the above-explained inspection method. When the pattern is determined as a non-defective pattern as a result of the inspection, the remaining manufacturing process is continuously performed with respect to the entire production lot to which the sampled substrate belongs to. On the other hand, when the pattern is determined as a defective pattern as a result of the inspection and rework processing is possible, the rework processing is performed with respect to the production lot to which the substrate having the pattern determined as a defective pattern formed thereon belongs to. Upon completion of the rework processing, a substrate is again sampled from the production lot to again inspect a pattern. When the sampled substrate is determined as a non-defective unit in the re-inspection of the pattern, the remaining manufacturing process is implemented with respect to the production lot on which the rework processing is finished. Further, when the rework processing is impossible, the production lot to which the substrate having the pattern determined as a defective pattern belongs to is discarded. When a defect occurrence factor can be analyzed, an analysis result is fed back to, e.g., a person in charge of design or a person in charge of upstream processes.

What is claimed is:

1. A pattern evaluation apparatus comprising:
a variation pattern group generation unit configured to receive information on a first reference pattern serving as evaluation reference of an inspection pattern, vary a process parameter for manufacturing the first reference pattern, and generate a variation pattern group comprising a plurality of patterns that are varied in shape from the first reference pattern according to a plurality of obtained process parameters, respectively;
a detection unit configured to receive information on a second reference pattern serving as reference in calculating a shape variation amount in the variation pattern group, detect edge points of the second reference pattern and the variation pattern group, and output coordinate information of the detected edge points;
an edge point association unit configured to conduct mutual association between the edge points of the second reference pattern and the edge points of the variation pattern group;
a shape variation amount calculation unit configured to calculate a shape variation amount in the variation pattern group from the coordinate information of the associated edge points;
a shape variation amount addition unit configured to add the calculated shape variation amount to information of the edge points of the second reference pattern; and
a pattern matching unit configured to conduct matching between the second reference pattern and the inspection pattern by using the second reference pattern with the shape variation amount being added.

2. The apparatus of claim 1, further comprising a difference quantifying unit configured to quantify a difference between the second reference pattern and the inspection pattern by using the second reference pattern with the shape variation amount being added.

3. The apparatus of claim 2,
wherein the difference quantifying unit outputs an evaluation index of the inspection pattern on the basis of the quantified difference.

4. The apparatus of claim 1,
wherein the pattern matching unit determines weighting according to the shape variation amount added to the second reference pattern, and conducts the matching between the second reference pattern and the inspection pattern according to the determined weighting.

5. The apparatus of claim 4,
wherein the pattern matching unit determines the weighting in proportion to magnitude of the shape variation amount added to the second reference pattern.

6. A method of evaluating a pattern comprising:
generating a first reference pattern serving as evaluation reference of an inspection pattern;
varying a process parameter for manufacturing the first reference pattern and generating a variation pattern group comprising a plurality of patterns that are varied in shape from the first reference pattern according to a plurality of obtained process parameters, respectively;
defining a pattern which serves as reference in calculating a shape variation amount in the variation pattern group, as a second reference pattern;
obtaining coordinates of edge points of the second reference pattern and the variation pattern group;
conducting association between the edge points of the second reference pattern and the edge points of the variation pattern group;
calculating a shape variation amount in the variation pattern group from the coordinates of the associated edge points;
adding the calculated shape variation amount to information of the edge points of the second reference pattern; and
conducting matching between the inspection pattern and the second reference pattern with the shape variation amount being added.

7. The method of claim 6, further comprising quantifying a difference between the second reference pattern and the inspection pattern by using the second reference pattern with the shape variation amount being added.

8. The method of claim 7, further comprising outputting an evaluation index of the inspection pattern on the basis of the quantified difference.

9. The method of claim 6, further comprising determining weighting according to the shape variation amount added to the second reference pattern,
wherein the matching between the second reference pattern and the inspection pattern is conducted according to determined weighting.

10. The method of claim 9,
wherein the weighting is determined in proportion to magnitude of the shape variation amount added to the second reference pattern.
